(19) United States
(12) Patent Application Publication
(10) Pub. No.: US 2008/0309851 A1
(43) Pub. Date: Dec. 18, 2008

(54) FLAT LIGHT SOURCE UNIT, METHOD FOR MANUFACTURING THE SAME, AND BACKLIGHT ASSEMBLY AND LIQUID CRYSTAL DISPLAY HAVING THE SAME

(75) Inventors: Hyuk Hwan Kim, Asan-Si (KR); Seok Hyun Nam, Seoul (KR); Hee Tae Kim, Yongin-Si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/108,578

(22) Filed: Apr. 24, 2008

(30) Foreign Application Priority Data
Jun. 15, 2007 (KR) 10-2007-0058740

(51) Int. Cl. G02F 1/13357; H01J 1/02

(52) U.S. Cl. 349/72; 313/484; 313/491; 313/10

(57) ABSTRACT

A flat light source unit includes a discharge tube including discharge channels and partitions formed between the discharge channels, a main electrode portion formed at first and second ends of the discharge channels, a sub-electrode portion connected to the main electrode portion, and a thermistor connected between the main electrode portion and the sub-electrode portion and having a resistance value which changes depending on temperature. There are also provided a method for manufacturing the flat light source unit, and a backlight assembly and a liquid crystal display (“LCD”) having the flat light source unit.

This application claims priority to Korean Patent Application No. 10-2007-0058740 filed on Jun. 15, 2007, and all the benefits accruing therefrom under 35 U.S.C. §119, the contents of which in its entirety are herein incorporated by reference.

### BACKGROUND OF THE INVENTION

1. Field of the Invention

The present invention relates to a flat light source unit, a method for manufacturing the same, and a backlight assembly and a liquid crystal display (“LCD”) having the same, and more particularly, to a flat light source unit including sub-electrodes, a method for manufacturing the flat light source unit, and a backlight assembly and an LCD having the same.

2. Description of the Related Art

A liquid crystal display (“LCD”) displays desired images on an LCD panel by adjusting an amount of transmitted light in accordance with image signals applied to a number of control switches arrayed in a matrix form. Such an LCD is not a self light-emitting device and thus needs a light source such as a backlight. The backlight is classified into an edge type and a direct type according to the position of a light source. In the edge type, a light source is installed at an edge of an LCD panel such that the LCD panel is irradiated with light generated from the light source through a transparent light guide plate positioned under the LCD panel. In the direct type, a plurality of light sources is positioned under an LCD panel such that the entire surface of the LCD panel is directly irradiated with light generated from the light sources. However, in a conventional light source, light loss occurs due to an optical member, such as a light guide plate or diffusion plate, so that light efficiency lowers and luminance uniformity is degraded.

Therefore, a flat light source such as a flat fluorescent lamp has been developed as an alternative light source to a conventional direct type backlight unit. Electrodes of the flat light source are positioned at the outside, so that it can be driven in a parallel mode. Additionally, the flat light source can be easily manufactured compared to a cold cathode fluorescent lamp (“CCFL”) and an external electrode fluorescent lamp (“EEFL”).

### BRIEF SUMMARY OF THE INVENTION

The flat light source structurally requires a driving voltage considerably higher than the CCFL or EEFL. Particularly, when the flat light source is driven at low temperatures (e.g., 0° C. or less), vapor pressure of mercury in the lamp rapidly decreases and thus the starting voltage and discharge sustain voltage of the lamp greatly increase. In such a case where the starting voltage of the lamp greatly increases, the light may not be uniformly emitted due to a channeling problem in which discharge current is concentrated to some of discharge channels.

Exemplary embodiments of the present invention include a flat light source unit capable of preventing a channeling problem and thus securing reliability at a low temperature when the flat light source operates at low temperature, a method of manufacturing the flat light source, and a backlight assembly and a liquid crystal display (“LCD”) having the flat light source unit.

According to exemplary embodiments of the present invention, there is provided a flat light source unit, including a discharge tube including discharge channels and partitions formed between the discharge channels, a main electrode portion formed at first and second ends of the discharge channels, a sub-electrode portion connected to the main electrode portion, and a thermistor connected between the main electrode portion and the sub-electrode portion and having a resistance value which changes depending on temperature.

The sub-electrode portion may be formed substantially on the partitions of the discharge tube.

The discharge tube may include a first substrate having a plurality of discharge spaces, and a second substrate bonded to the first substrate.

The discharge tube may further include a reflective layer formed on the second substrate, a phosphor layer formed on the reflective layer, and a discharge gas injected in the discharge channels.

The thermistor may include a positive temperature coefficient thermistor, in which a resistance value increases when temperature rises.

The sub-electrode portion may be made of a transparent conductive material.

The plurality of discharge channels may extend to a first direction to be parallel with one another.

The main electrode portion may be formed in a second direction intersecting the first direction.

The sub-electrode portion may be formed substantially in the first direction.

The sub-electrode portion may include a connection part having a first end connected to the main electrode portion, and a protrusion part formed to protrude from a second end of the connection part to partially overlap with the discharge channel.

The connection part of the sub-electrode portion may extend up to a central region of the discharge tube.

The main electrode portion may include a first main electrode formed at a first end of the first substrate and at a first end of the second substrate opposite to the first end of the first substrate, and a second main electrode formed at a second end of the first substrate and at a second end of the second substrate opposite to the first end of the first substrate.

The sub-electrode portion may include at least one first sub-electrode connected to the first main electrode, and at least one second sub-electrode connected to the second main electrode.

The first and second sub-electrodes may be formed on the second substrate.

The at least one first sub-electrode may be formed on the second substrate and the at least one second sub-electrode may be formed on the first substrate.

Protrusion parts of the first and second sub-electrodes may be arranged to be opposite to each other, or to be out of line with each other, the protrusion parts being spaced apart from each other.

A plurality of the first sub-electrodes and a plurality of the second sub-electrodes may be provided.

First ends of connection parts of respective first sub-electrodes may be connected to each other, and a first thermistor may be positioned between one of the connection parts and the first main electrode, and first ends of the connection parts of respective second sub-electrodes may be connected to each other, and a second thermistor may be positioned between one of the connection parts and the second main electrode.

According to other exemplary embodiments of the present invention, a backlight assembly includes the flat light source unit so configured, an optical sheet positioned over the flat light source unit, and a reception member which accommodates the flat light source unit and the optical sheet.

According to further exemplary embodiments of the present invention, an LCD includes the backlight assembly so configured, and an LCD panel positioned over the backlight assembly to display an image.

According to still further exemplary embodiments of the present invention, a method for manufacturing a flat light source unit includes forming a discharge tube including discharge channels and partitions formed between the discharge channels, forming a main electrode portion at first and second ends of the discharge channels, forming a sub-electrode portion connected to the main electrode portion, and connecting a thermistor between the main electrode portion and the sub-electrode portion, the thermistor having a resistance value which changes depending on temperature.

### BRIEF DESCRIPTION OF THE DRAWINGS

The above and other aspects, features and advantages of the present invention will become apparent from the following description of exemplary embodiments given in conjunction with the accompanying drawings, in which:

FIG. 1 is a schematic perspective view of an exemplary flat light source unit according to a first exemplary embodiment of the present invention;

FIG. 2 is a front view of the exemplary flat light source unit according to the first exemplary embodiment of the present invention;

FIG. 3 is a rear view of the exemplary flat light source unit according to the first exemplary embodiment of the present invention;

FIGS. 4 and 5 are sectional views of the exemplary flat light source unit taken along lines I-I and II-II in FIG. 1, respectively;

FIG. 6 is a sectional view of the exemplary flat light source unit taken along line III-III in FIG. 3;

FIG. 7 is a rear view of an exemplary flat light source unit according to a second exemplary embodiment of the present invention;

FIG. 8 is a rear view of an exemplary flat light source unit according to a third exemplary embodiment of the present invention;

FIG. 9 is a schematic perspective view of an exemplary flat light source unit according to a fourth exemplary embodiment of the present invention;

FIG. 10 is a rear view of the exemplary flat light source unit according to the fourth exemplary embodiment of the present invention; and

FIG. 11 is an exploded perspective view of an exemplary backlight assembly having an exemplary flat light source unit and an exemplary liquid crystal display (“LCD”) having the same according to an exemplary embodiment of the present invention.

### DETAILED DESCRIPTION OF THE INVENTION

The invention will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, exemplary embodiments of the present invention will be described in detail with reference to the accompanying drawings.

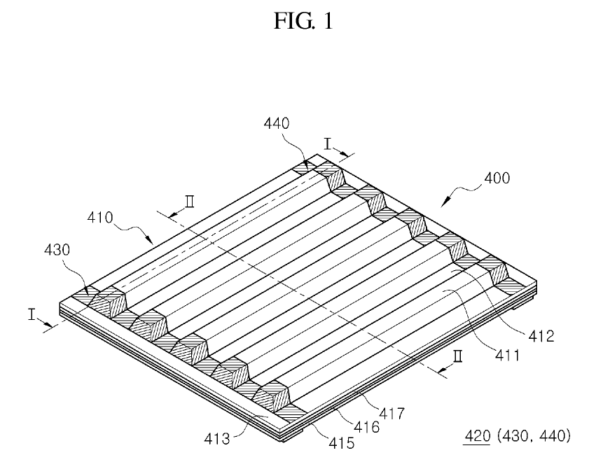

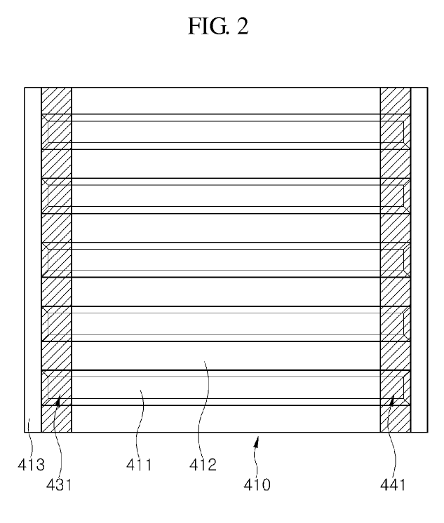

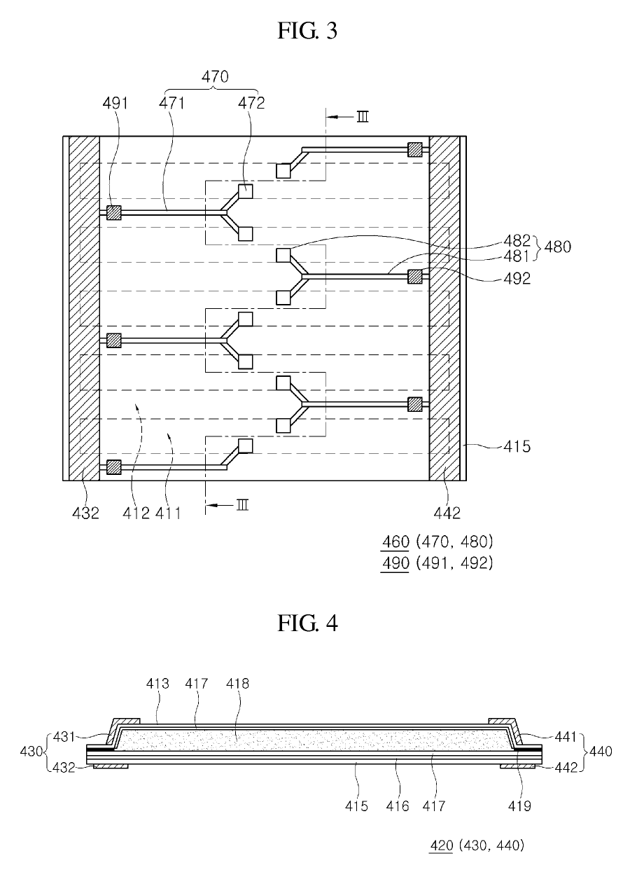

FIG. 1 is a schematic perspective view of an exemplary flat light source unit according to a first exemplary embodiment of the present invention, FIG. 2 is a front view of the exemplary flat light source unit according to the first exemplary embodiment of the present invention, and FIG. 3 is a rear view of the exemplary flat light source unit according to the first exemplary embodiment of the present invention.

Referring to FIGS. 1 to 3, a flat light source unit 400 includes a discharge tube 410, a main electrode portion 420, a sub-electrode portion 460 and a thermistor 490.

The discharge tube 410 includes a plurality of discharge channels 411 and partitions 412 formed between the plurality of discharge channels 411, such that the discharge channels 411 and the partitions 412 are alternately arranged. A discharge gas is injected in the discharge channels 411 of the discharge tube 410, and discharge is generated inside the discharge channels 411. The partition 412 serves as a barrier for isolating adjacent discharge channels 411 from each other. The discharge tube 410 is generally formed in the shape of a rectangle or square flat plate. Each discharge channel 411 is formed to extend in a first direction (e.g., a long-side direction or lateral direction), and is substantially bar-shaped, such as being generally formed in a shape of an “I”. Although the discharge channel 411 is formed in the shape of “I” in this embodiment, the shape of the discharge channel 411 is not limited thereto, but may vary.

The discharge tube 410 includes a first substrate 413, a second substrate 415 arranged opposite to the first substrate 413, and a sealant 419 (shown in FIGS. 4 and 5) for bonding the first and second substrates 413 and 415 to each other. The first substrate 413 has a surface formed with a sawtooth shape in order to form a plurality of discharge spaces 414 (see FIG. 5). The second substrate 415 is formed in a shape of a flat plate. By bonding the first and second substrates 413 and 415 with the sealant 419, the discharge tube 410 including the discharge channels 411 and the partitions 412 is formed. Although the second substrate 415 is formed in the shape of a flat plate in this embodiment, it is not limited thereto. That is, in an alternative exemplary embodiment, like the first substrate 413, the second substrate 415 may be formed in a sawtooth shape to have a plurality of discharge spaces defined therein.

The main electrode portion 420 is formed at both ends of the plurality of discharge channels 411 to supply voltage required for main discharge to the plurality of discharge channels 411. The main electrode portion 420 includes a first main electrode 430 formed at first ends of the plurality of discharge channels 411, and a second main electrode 440 formed at second ends of the plurality of discharge channels 411, where the first ends are opposite the second ends.

The first main electrode 430 includes a first upper electrode 431 formed on one side corresponding to a first end of the first substrate 413 and a first lower electrode 432 formed on one side corresponding to a first end of the second substrate 415 opposite to the one side of the first substrate 413. Further, the second main electrode 440 includes a second upper electrode 441 formed on the other side corresponding to a second end of the first substrate 413 and a second lower electrode 442 formed on the other side corresponding to a second end of the second substrate 415 opposite to the other side of the first substrate 413. In an exemplary embodiment, the first and second upper electrodes 431, 441 may be disposed on an outer surface of the first substrate 413, and the first and second lower electrodes 432, 442 may be disposed on an outer surface of the second substrate 415, where the outer surfaces of the first and second substrates 413, 415 face away from each other.

Each of the first and second main electrodes 430 and 440 extends in a second direction (e.g., a short-side direction or longitudinal direction) to intersect the discharge channels 411, and is substantially bar-shaped, such as being generally formed in a shape of an “I”.

The sub-electrode portion 460 is connected to the main electrode portion 420 and extends to a region in which weak discharge is generated. The sub-electrode portion 460 is mainly formed on the partitions 412. The sub-electrode portion 460 generates the weak discharge before main discharge to supply seed electrons required for the main discharge.

The sub-electrode portion 460 includes first sub-electrodes 470 connected to the first main electrode 430 and second sub-electrodes 480 connected to the second main electrode 440. In this exemplary embodiment, the first and second sub-electrodes 470 and 480 are formed on the rear surface of the discharge tube 410, i.e., on the outer surface of the second substrate 415, and formed mainly on the partitions 412 to be parallel with the discharge channels 411.

Each first sub-electrode 470 includes a connection part 471 and at least one protrusion 472. A first end of the connection part 471 is connected to the first lower electrode 432 of the first main electrode 430. The protrusion 472 is formed to protrude from a second end of the connection 471 and to partially overlap with the discharge channel 411. The first sub-electrode 470 may include one protrusion 472 protruding from the second end of the connection 471, or two or more protrusions 472 branching and protruding from the second end of the connection 471. If two or more protrusions 472 are provided, then the connection part 471 may include branches at the second end thereof to space the protrusions 472 from each other.

Each second sub-electrode 480 includes a connection part 481 and at least one protrusion 482. A first end of the connection 481 is connected to the second lower electrode 442 of the second main electrode 440. The protrusion 482 is formed to protrude from a second end of the connection 481 and to partially overlap with the discharge channel 411. The first sub-electrode 480 may include one protrusion 482 protruding from the second end of the connection 481, or two or more protrusions 482 branching and protruding from the second end of the connection 481. If two or more protrusions 482 are provided, then the connection part 481 may include branches at the second end thereof to space the protrusions 482 from each other.

The first and second sub-electrodes 470 and 480 are formed to extend to the central region of the discharge tube 410, generally midway between the first and second main electrodes 430, 440, and arranged to be spaced apart from each other.

Further, each partition 412 of the discharge tube 410 can include only one of the first and second sub-electrodes 470 and 480. The first and second sub-electrodes 470 and 480 are alternately arranged on the partitions 412. As a result, the protrusions 472 and 482 of the first and second sub-electrodes 470 and 480 are arranged to be out of line with each other and to be spaced apart from each other. A protrusion 427 and a protrusion 482 may overlap the same discharge channel 411.

The first and second sub-electrodes 470 and 480 may be made of a transparent material, e.g., indium tin oxide (“ITO”), indium zinc oxide (“IZO”) or the like. In one exemplary embodiment, only the protrusions 472 and 482 of the first and second sub-electrodes 470 and 480 may be formed of a transparent conductive material. Alternatively, the first and second sub-electrodes 470 and 480 may be entirely formed of a transparent conductive material. As such, if the first and second sub-electrodes 470 and 480 are formed of a transparent conductive material, it is possible to minimize generation of a dark portion in an overlapping part with the discharge channel 411.

The thermistor 490 is connected in series between the main electrode portion 420 and the sub-electrode portion 460. A positive temperature coefficient thermistor, in which a resistance value increases as temperature rises, is used as the thermistor 490.

In the positive temperature coefficient thermistor, a resistance value increases more than several thousands times at a specific temperature, e.g., a Curie temperature or switching temperature, or higher. In an exemplary embodiment, a perovskite-based (barium Ba, strontium Sr)TiO₃ ceramic element is used as the positive temperature coefficient thermistor. The (Ba, Sr)TiO₃ element has a Curie temperature between 0 and 100° C. depending on the content of Sr. A (Ba, Sr)TiO₃ element having a Curie temperature of about 30 to about 40° C. is used in this exemplary embodiment. Resistivity of the (Ba, Sr)TiO₃ element increases from about a few tens Ωcm to about 10⁵ Ωcm or so at the Curie temperature or higher.

The thermistor 490 includes first thermistors 491 and second thermistor 492. The first thermistor 491 is disposed adjacent a region in which the first sub-electrodes 470 and the first main electrode 430 are connected, and the second thermistor 492 is disposed adjacent a region in which the second sub-electrodes 480 and the second main electrode 440 are connected. In an exemplary embodiment, the sub-electrode portion 460 includes three first sub-electrodes 470 and three second sub-electrodes 480. Depending on the size of the flat light source unit 400, more or less first and second sub-electrodes 470, 480 may be provided. The first thermistors 491 are positioned at first ends of the first sub-electrodes 470, and the second thermistors 492 are positioned at first ends of the second sub-electrodes 480, respectively. That is, the thermistors 490 are individually connected to every sub-electrode 460.

The operation of the flat light source unit 400 according to this exemplary embodiment will now be described. The impedance in the protrusions 472 and 482 of the sub-electrode portion 460 is much larger than the resistance value of the thermistor 490 when the flat light source unit 400 is initially driven at a normal or low temperature. Therefore, most of the voltage supplied to the sub-electrode portion 460 through the main electrode portion 420 is applied to the protrusions 472 and 482. At this time, weak discharge is generated due to the protrusions 472 and 482 of the sub-electrode portion 460. Since the connections 471 and 481 of the sub-electrode portion 460 are formed not on the discharge channels 411 but on the partitions 412, the influence on the discharge generated in the discharge channel 411 is restricted to a minimum. If seed electrons are produced by the weak discharge and the voltage required for the main discharge is applied to the plurality of discharge channels 411 through the main electrode portion 420, the main discharge is generated.

Further, the flat light source unit 400 is heated to about 30 to about 40° C. or higher within about 3 to about 10 minutes after it starts operation. Particularly, the thermistor 490 adjacent to the main electrode portion 420 is heated to about 60 to about 70° C. or higher due to heat generation in the flat light source unit 400 itself. Then, the resistivity of the thermistor 490 rapidly increases, and discharge current flowing through the sub-electrode portion 460 and to the protrusions 472, 482 greatly decreases. Accordingly, the influence of the sub-electrode portion 460 on the main discharge in the discharge channel 411 is restricted to a minimum.

Although it is described in the aforementioned exemplary embodiment that the first and second sub-electrodes 470 and 480 are formed mainly on the partitions 412, the present invention is not limited thereto. That is, the first and second sub-electrodes 470 and 480 may alternatively be formed on the discharge channels 411.

In an exemplary embodiment of the present invention, the sub-electrode portion 460 is operated only during the initial driving stage of the flat light source unit 400, so that reliability of low temperature driving and initial discharge characteristics of the light source can be ensured without large costs. Further, local deterioration of phosphors caused by forming a sub-electrode portion 460, additional requirement of a power supply and the like, can be minimized in the normal driving stage of the flat light source unit 400.

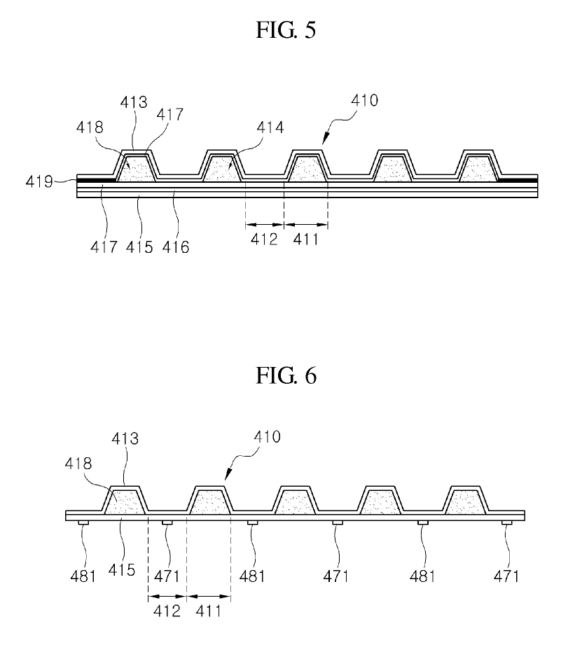

FIGS. 4 and 5 are sectional views of the exemplary flat light source unit taken along lines I-I and II-II in FIG. 1, respectively, and FIG. 6 is a sectional view of the exemplary flat light source unit taken along line III-III in FIG. 3.

Referring to FIGS. 4 to 6, the flat light source unit 400 includes the discharge tube 410, the main electrode portion 420, the sub-electrode portion 460 (as shown in FIG. 3) and the thermistor 490 (as shown in FIG. 3).

The discharge tube 410 includes the plurality of discharge channels 411, partitions 412 formed between the plurality of discharge channels 411, a reflective layer 416, a phosphor layer 417 and a discharge gas 418.

The discharge tube 410 includes the first substrate 413 having the plurality of discharge channels 411, the second substrate 415 arranged opposite to the first substrate 413, and a sealant 419 for bonding the first and second substrates 413 and 415 to each other.

The reflective layer 416 and the phosphor layer 417 are sequentially laminated on the second substrate 415, and the phosphor layer 417 is also formed on the inner surface of the first substrate 413. The discharge gas 418 is injected in the discharge channels 411.

The first main electrode 430 is formed at first ends of the plurality of discharge channels 411, and the second main electrode 440 is formed at second ends of the plurality of discharge channels 411. The connection part 471 of the first sub-electrode is connected to the first main electrode 430 and formed on the partition 412. The connection part 481 of the second sub-electrode is connected to the second main electrode 440 and also formed on the partition 412.

Plasma discharge is generated in the respective discharge channels 411 by the voltage applied through the main electrode portion 420 from the outside. Ultraviolet light generated by the plasma discharge is changed into visible light while passing through the phosphor layer 417, whereby the visible light is then emitted to the outside of the flat light source unit 400.

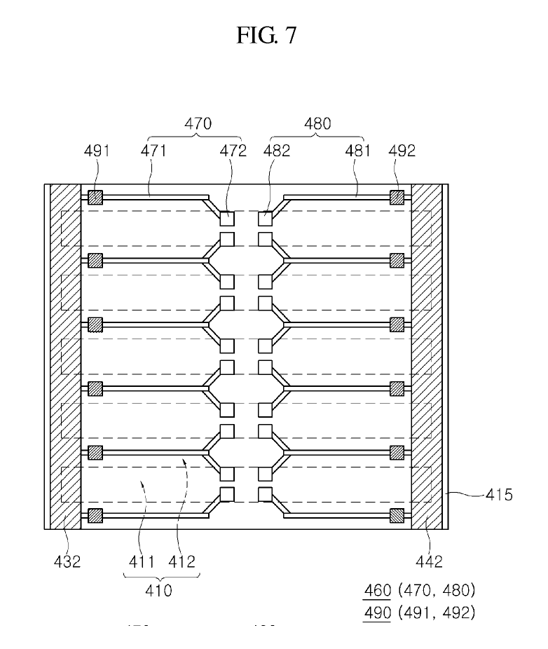

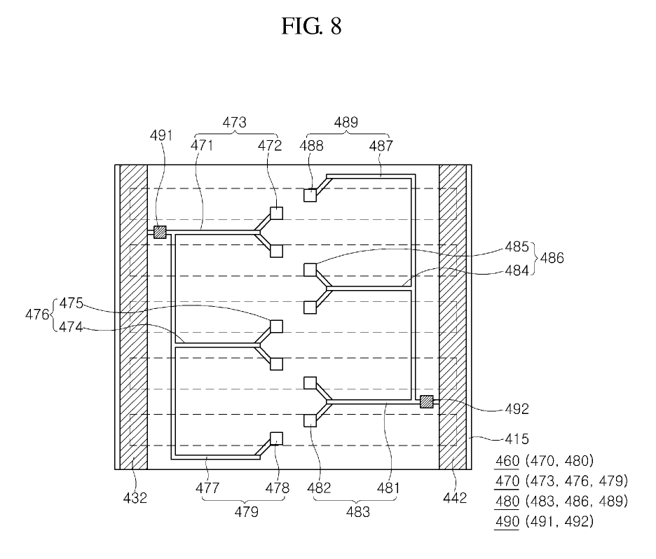

FIG. 7 is a rear view of an exemplary flat light source unit according to a second exemplary embodiment of the present invention. The second exemplary embodiment of the present invention shown in FIG. 7 is different from the aforementioned first exemplary embodiment in a shape of the sub-electrode portion, and the other components may be almost identical to each other. Accordingly, the different configurations will be mainly described below.

Referring to FIG. 7, a sub-electrode portion 460 includes first sub-electrodes 470 connected to the first main electrode 430 and second sub-electrodes 480 connected to the second main electrode 440. The first sub-electrode 470 includes the connection part 471 and the at least one protrusion 472. A first end of the connection part 471 is connected to the first lower electrode 432 of the first main electrode 430. The protrusion 472 is formed to protrude from a second end of the connection part 471 and to partially overlap with the discharge channel 411. The second sub-electrode 480 includes the connection part 481 and the at least one protrusion 482. A first end of the connection part 481 is connected to the second lower electrode 442 of the second main electrode 440. The protrusion 482 is formed to protrude from a second end of the connection part 481 and to partially overlap with the discharge channel 411.

The first and second sub-electrodes 470 and 480 are formed to extend towards the centerline of the discharge tube 410, between the first and second main electrodes 430, 440, and arranged to be spaced apart from each other. Further, the first and second sub-electrodes 470 and 480 are arranged opposite to each other on the respective partitions 412 of the discharge tube 410. As a result, the protrusions 472 and 482 of the first and second sub-electrodes 470 and 480 are arranged opposite to each other while being spaced apart from each other.

In this exemplary embodiment, the sub-electrode portion 460 includes six first sub-electrodes 470 and six second sub-electrodes 480. Depending on the size of the flat light source unit 400, more or less first and second sub-electrodes 470, 480 may be provided. The first thermistors 491 are arranged at first ends of the respective first sub-electrodes 470, and the second thermistors 492 are arranged at first ends of the respective second sub-electrodes 480. That is, thermistors 490 are individually connected to every sub-electrode 470, 480.

FIG. 8 is a rear view of an exemplary flat light source unit according to a third exemplary embodiment of the present invention. The third exemplary embodiment of the present invention shown in FIG. 8 is different from the aforementioned exemplary embodiments in the arrangement of the sub-electrode portion and the thermistors, and the other components may be almost identical to each other. Accordingly, the different configurations will be mainly described below.

Referring to FIG. 8, a sub-electrode portion 460 includes a first sub-electrode 470 connected to the first lower electrode 432 of the first main electrode 430, and a second sub-electrode 480 connected to the second lower electrode 442 of the second main electrode 440.

The first sub-electrode 470 includes a plurality of first sub-electrodes, e.g., three first sub-electrodes 473, 476 and 479. The second sub-electrode also includes a plurality of second sub-electrodes, e.g., three second sub-electrodes 483, 486 and 489.

First ends of respective connection parts 471, 474 and 477 of the first sub-electrode 470 are connected to one another. A first thermistor 491 is positioned at the first end of any one of the connection parts 471, 474 and 477 to connect the first sub-electrode 470 to the first lower electrode 432 of the first main electrode 430. Although the first thermistor 491 is illustrated as connected to the first end of the connection 471 of the first sub-electrode 470 in this exemplary embodiment, the present invention is not limited thereto. That is, the first thermistor 491 may be connected to any first end of the other connection parts.

Similarly, first ends of respective connection parts 481, 484 and 487 of the second sub-electrode 480 are connected to one another. A second thermistor 492 is positioned at a first end of any one of the connection parts 481, 484 and 487 to connect the second sub-electrode 480 to the second lower electrode 442 of the second main electrode 440. Although the second thermistor 492 is illustrated as connected to a first end of the connection part 481 of the second sub-electrode 480 in this exemplary embodiment, the present invention is not limited thereto. That is, the second thermistor 492 may be connected to any first end of the other connection parts.

The arrangement structure of this exemplary embodiment will now be described in detail. The first sub-electrode 473 includes a connection part 471 and protrusions 472. The first end of the connection part 471 is connected to the first lower electrode 432 of the first main electrode 430, and the protrusions 472 are formed to protrude from a second end of the connection 471 and to partially overlap with the discharge channel 411. Further, the first sub-electrode 476 includes a connection part 474 and protrusions 475. The first end of the connection part 474 is connected to the connection part 471 of the first sub-electrode 473, and the protrusions 475 are formed to protrude from a second end of the connection part 474. Although the connection part 474 of the first sub-electrode 476 is formed in a bent shape, the present invention is not limited thereto. Furthermore, the first sub-electrode 479 includes a connection part 477 and a protrusion 478. The first end of the connection part 477 is connected to the connection part 474 of the first sub-electrode 476, and the protrusion 478 is formed to protrude from a second end of the connection part 477. Although the connection part 477 of the first sub-electrode 479 is formed in a bent shape, the present invention is not limited thereto. The first thermistor 491 is formed at the first end of the connection part 471 of the first sub-electrode 473. That is, first thermistors 491 are not individually connected to all the first sub-electrodes 470, but one thermistor 491 is connected to a plurality of first sub-electrodes 470.

The second sub-electrode 480 includes second sub-electrodes 483, 486, 489, each having connection parts 481, 484, 487 and at least one protrusion 482, 485, 488, respectively. The first ends of the connection parts 481, 484, 487 are connected to each other. The second thermistor 492 is formed at a first end of the connection part 481 of the second sub-electrode 483, but may be formed at the first end of any of the connections parts. Since the second sub-electrode 480 is configured to be similar to the first sub-electrode 470, the detailed description of the second sub-electrode 480 will be omitted. According to this exemplary embodiment, the number of thermistors 490 is remarkably reduced, so that the material costs can be reduced and a manufacturing process can be simplified.

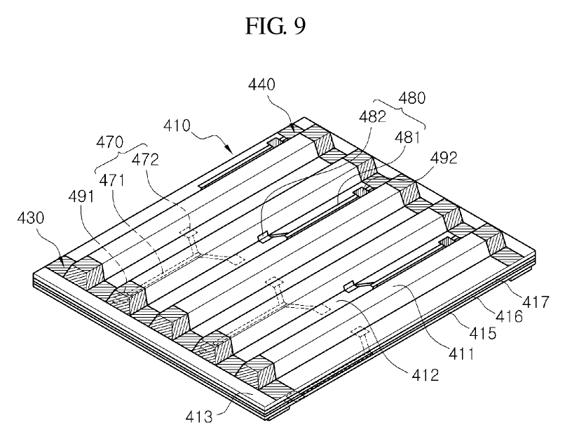

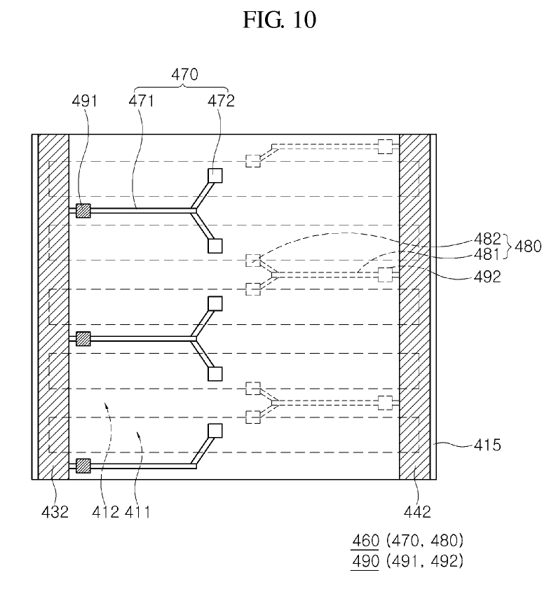

FIG. 9 is a schematic perspective view of an exemplary flat light source unit according to a fourth exemplary embodiment of the present invention, and FIG. 10 is a rear view of the exemplary flat light source unit according to the fourth exemplary embodiment of the present invention. The fourth exemplary embodiment of the present invention shown in FIGS. 9 and 10 is different from the aforementioned exemplary embodiments in the arrangement of the sub-electrode portion and the thermistors, and the other components may be almost identical to each other. Accordingly, the different configurations will be mainly described below.

Referring to FIGS. 9 and 10, a sub-electrode portion 460 includes first sub-electrodes 470 connected to the first main electrode 430 and second sub-electrodes 480 connected to the second main electrode 440. The first sub-electrodes 470 are formed on the rear surface of the discharge tube 410, i.e., on the second substrate 415. The first sub-electrodes 470 are formed to be parallel with the discharge channels 411 on the partitions 412. Further, the second sub-electrodes 480 are formed on the front surface of the discharge tube 410, i.e., on the first substrate 413. The second sub-electrodes 480 are formed to be parallel with the discharge channels 411 on the partitions 412.

Each of the first sub-electrodes 470 includes a connection part 471 and at least one protrusion 472, which are formed on the second substrate 415. A first end of the connection part 471 is connected to the first lower electrode 432 of the first main electrode 430, and the protrusion 472 is formed to protrude from a second end of the connection part 471 to partially overlap with the discharge channel 411. The first sub-electrode 470 may include the protrusion 472 protruding from the second end of the connection part 471, or two or more protrusions 472 branching from the second end of the connection part 471.

Each of the second sub-electrodes 480 includes a connection part 481 and at least one protrusion 482, which are formed on the first substrate 413. A first end of the connection part 481 is connected to the second lower electrode 442 of the second main electrode 440, and the protrusion 482 is formed to protrude from a second end of the connection part 481 to partially overlap with the discharge channel 411. The second sub-electrode 480 may include the protrusion 482 protruding from the second end of the connection part 481, or two or more protrusions 482 branching from the second end of the connection part 481.

The first and second sub-electrodes 470 and 480 are formed to extend towards the centerline of the discharge tube 410, in an area between the first and second main electrodes 430, 440, and arranged to be spaced apart from each other. Further, in one exemplary embodiment, only one of the first and second sub-electrodes 470 and 480 are arranged on the respective partitions 412 of the discharge tube 410. The first and second sub-electrodes 470 and 480 are alternately arranged. As a result, the protrusions 472 and 482 of the first and second sub-electrodes 470 and 480 are arranged to be out of line with each other while being spaced apart from each other.

In this exemplary embodiment, the first and second sub-electrodes 470 and 480 are arranged on different planes to be formed in a vertically spaced structure, so that a stronger electric field is operated in a discharge channel 411 with respect to the same applied voltage as compared with a case where the first and second sub-electrodes 470 and 480 are arranged on the same plane. Consequently, the weak discharge can be better generated by a sub-electrode 460.

The aforementioned exemplary embodiments are merely exemplary embodiments of the flat light source unit according to the present invention. Alternative exemplary embodiments may include, for example, combinations of the aforementioned exemplary embodiments.

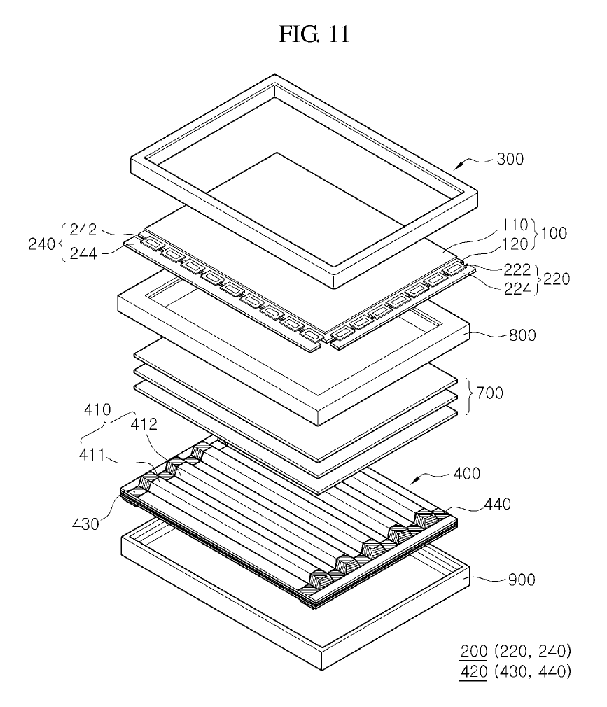

FIG. 11 is an exploded perspective view of an exemplary backlight assembly having an exemplary flat light source unit and a liquid crystal display (“LCD”) having the same according to an exemplary embodiment of the present invention.

Referring to FIG. 11, an LCD according to an exemplary embodiment of the present invention includes a backlight assembly having a flat light source unit 400, a mold frame 800, a plurality of optical sheets 700 and a bottom chassis 900, an LCD panel 100 arranged over the backlight assembly, a driving circuit unit 200, and a top chassis 300.

The LCD panel 100 may include an upper substrate 110 and a thin film transistor (“TFT”) substrate 120. The upper substrate 110 may include color filters and a common electrode. The TFT substrate 120 may include TFTs and pixel electrodes facing the common electrode. A liquid crystal layer may be formed between the upper substrate 110 and the TFT substrate 120.

The driving circuit unit 200, including gate driving circuit unit 220 and data driving circuit unit 240, is connected to the LCD panel 100. The driving circuit unit 200 includes a gate-side printed circuit board (“PCB”) 224 equipped with a control integrated circuit (“IC”) to apply predetermined gate signals to gate lines of the TFT substrate 120, a data-side PCB 244 equipped with a control IC to apply predetermined data signals to data lines of the TFT substrate 120, a gate-side flexible PCB 222 for connecting the TFT substrate 120 and the gate-side PCB 224, and a data-side flexible PCB 242 for connecting the TFT substrate 120 and the data-side PCB 244. The gate-side and data-side PCBs 224 and 244 are respectively connected to the gate-side and data-side flexible PCBs 222 and 242 so as to apply gate driving and external image signals. Although not shown, in an alternative exemplary embodiment, the gate-side and data-side PCBs 224 and 244 may be integrated into one PCB. Further, a driving IC is mounted on the flexible PCBs 222 and 242, so that red, green and blue (“RGB”) signals generated from the PCBs 224 and 244, digital power and the like are transmitted to the LCD panel 100. Although a tape-automated bonding (“TAB”) mounting method is described as an example in the embodiment of the present invention, in an alternative exemplary embodiment, a chip on glass (“COG”) in which a driving IC is mounted on not the flexible PCBs 222 and 242 but the TFT substrate 120 may be applied to this embodiment of the present invention.

The flat light source unit 400 includes a discharge tube 410, a main electrode portion 420, a sub-electrode portion (not shown) and a thermistor (not shown). During the initial driving stage of the flat light source unit 400, most voltage is applied to the sub electrode portion through the main electrode portion 420, so that positive discharge is generated. Then, after a certain time passes, the flat light source 400 is heated due to heat generation in itself. Accordingly, the resistivity of the thermistor rapidly increases, and the discharge current flowing through the sub-electrode portion is greatly reduced. Therefore, the discharge current flows through the main electrode portion 420, and the main discharge is generated using the discharge current flowing through the main electrode portion 420. As such, the weak discharge is generated before the main discharge using the sub-electrode portion to supply seed electrons required for the main discharge, whereby a channeling problem can be prevented. The channeling problem takes place in a conventional flat light source unit because the discharge current is concentrated on some discharge channels in the initial driving stage of a surface light source at low temperature.

The flat light source unit 400 is accommodated in the bottom chassis 900, and the plurality of optical sheets 700 are positioned over the flat light source unit 400. The mold frame 800 is positioned on the flat light source unit 400 to provide a space in which the LCD panel 100 is seated.

As described above, according to the present invention, a sub-electrode is formed mainly on partitions of a discharge tube, whereby the reliability of low temperature driving can be ensured.

Further, a thermistor is provided together with a sub-electrode and thus the sub-electrode operates only in the initial driving stage of the flat light source unit, so that reliability of low temperature driving and stable initial discharge characteristics can be ensured with minimum costs. In addition, a disadvantage caused by the sub-electrode during normal driving stage can be minimized.

Furthermore, since an additional power supply for supplying power to a sub-electrode is not required, manufacturing costs can be reduced.

In addition, the reliability of low temperature driving of the flat light source unit can be ensured, and a large-sized flat light source unit can be implemented due to the simple structure.

The above descriptions are merely exemplary embodiments of a flat light source unit and a backlight assembly and an LCD having the same according to the present invention, so that the present invention is not limited thereto. The true scope of the present invention should be defined to the extent that those skilled in the art can make various modifications and changes thereto without departing from the scope of the invention, as defined by the appended claims.

What is claimed is:

1. A flat light source unit, comprising:
a discharge tube including discharge channels and partitions formed between the discharge channels;
a main electrode portion formed at first and second ends of the discharge channels;
a sub-electrode portion connected to the main electrode portion; and
a thermistor connected between the main electrode portion and the sub-electrode portion and having a resistance which changes depending on temperature.

2. The flat light source unit as claimed in claim 1, wherein the sub-electrode portion is substantially formed on the partitions of the discharge tube.

3. The flat light source unit as claimed in claim 1, wherein the discharge tube includes:
a first substrate having a plurality of discharge spaces; and
a second substrate bonded to the first substrate.

4. The flat light source unit as claimed in claim 3, wherein the discharge tube further includes:
a reflective layer formed on the second substrate;
a phosphor layer formed on the reflective layer; and
a discharge gas injected in the discharge channels.

5. The flat light source unit as claimed in claim 3, wherein the sub-electrode portion comprises:
a connection part having a first end connected to the main electrode portion; and
a protrusion part formed to protrude from a second end of the connection part to partially overlap with the discharge channel.

6. The flat light source unit as claimed in claim 5, wherein the connection part of the sub-electrode portion extends to a central region of the discharge tube.

7. The flat light source unit as claimed in claim 5, wherein the main electrode portion comprises:
a first main electrode formed at a first end of the first substrate and at a first end of the second substrate opposite to the first end of the first substrate; and
a second main electrode formed at a second end of the first substrate and at a second end of the second substrate opposite to the second end of the first substrate.

8. The flat light source unit as claimed in claim 7, wherein the sub-electrode portion comprises:
at least one first sub-electrode connected to the first main electrode; and
at least one second sub-electrode connected to the second main electrode.

9. The flat light source unit as claimed in claim 8, wherein the first and second sub-electrodes are formed on the second substrate.

10. The flat light source unit as claimed in claim 8, wherein the at least one first sub-electrode is formed on the second substrate and the at least one second sub-electrode is formed on the first substrate.

11. The flat light source unit as claimed in claim 8, wherein protrusion parts of the first and second sub-electrodes are arranged to be opposite to each other, or to be out of line with each other, the protrusion parts being spaced apart from each other.

12. The flat light source unit as claimed in claim 8, wherein a plurality of the first sub-electrodes and a plurality of the second sub-electrodes are provided.

13. The flat light source unit as claimed in claim 12, wherein first ends of connection parts of respective first sub-electrodes are connected to each other, and a first thermistor is positioned between one of the connection parts and the first main electrode; and first ends of connection parts of the respective second sub-electrodes are connected to each other, and a second thermistor is positioned between one of the connection parts and the second main electrode.

14. The flat light source unit as claimed in claim 1, wherein the thermistor includes a positive temperature coefficient thermistor in which a resistance increases when temperature rises.

15. The flat light source unit as claimed in claim 1, wherein the sub-electrode portion is made of a transparent conductive material.

16. The flat light source unit as claimed in claim 1, wherein the discharge channels extend in a first direction to be parallel with one another.

17. The flat light source unit as claimed in claim 16, wherein the main electrode portion is formed in a second direction intersecting the first direction.

18. The flat light source unit as claimed in claim 17, wherein the sub-electrode portion is formed substantially in the first direction.

19. A backlight assembly, comprising:
a flat light source unit including a discharge tube including discharge channels and partitions formed between the discharge channels, a main electrode portion formed at first and second ends of the discharge channels, a sub-electrode portion connected to the main electrode portion, and a thermistor connected between the main electrode portion and the sub-electrode portion and having a resistance which changes depending on temperature;
an optical sheet positioned over the flat light source unit; and
a receiving member which accommodates the flat light source unit and the optical sheet.

20. A liquid crystal display, comprising:
a backlight assembly including a flat light source unit having a discharge tube including discharge channels and partitions formed between the discharge channels, a main electrode portion formed at first and second ends of the discharge channels, a sub-electrode portion connected to the main electrode portion, and a thermistor connected between the main electrode portion and the sub-electrode portion and having a resistance which changes depending on temperature; an optical sheet positioned over the flat light source unit; and a receiving member which accommodates the flat light source unit and the optical sheet; and
a liquid crystal display panel positioned over the backlight assembly to display an image.

21. A method for manufacturing a flat light source unit, the method comprising:
forming a discharge tube including discharge channels and partitions formed between the discharge channels;
forming a main electrode portion at first and second ends of the discharge channels;
forming a sub-electrode portion connected to the main electrode portion; and
connecting a thermistor between the main electrode portion and the sub-electrode portion, the thermistor having a resistance which changes depending on temperature.
